(19) United States
(12) Patent Application Publication
(10) Pub. No.: US 2012/0134400 A1
(43) Pub. Date: May 31, 2012

(54) Testing Device and Method for a Multiple-Input Multiple-Output Wireless Terminal

(75) Inventors: Tiantian Ding, Guangdong Province (CN); Yang Guo, Guangdong Province (CN); Zhong Yu, Guangdong Province (CN); Zhou Zhi, Guangdong Province (CN)

(73) Assignee: ZTE CORPORATION, Shenzhen City, Guangdong Province (CN)

(21) Appl. No.: 13/258,038

(22) PCT Filed: Dec. 14, 2009
(86) PCT No.: PCT/CN09/75543

§ 371 Date: Feb. 8, 2012

(30) Foreign Application Priority Data
Aug. 21, 2009 (CN) 200910091475.5

(51) Int. Cl. H04W 24/08

(52) U.S. Cl. 375/224

(57) ABSTRACT

An apparatus and method for testing a multi-in multi-out (MIMO) wireless terminal are provided. In the apparatus, a MIMO transmission mode selecting unit includes: a mode selecting module, which is configured to select a MIMO downlink transmission mode currently requiring testing and trigger a corresponding MIMO downlink transmission module during the real-world over-the-air (OTA) test for the MIMO wireless terminal; and the downlink transmission module, which is configured to output downlink test signals which conform to the feature of the selected MIMO downlink transmission mode according to the triggering of the mode selecting module. The method includes: during the OTA test for the MEMO wireless terminal, selecting a MIMO downlink transmission mode currently requiring testing from multiple configured MIMO downlink transmission modes, and outputting downlink test signals that conform to the feature of the selected MIMO downlink transmission mode.

### TECHNICAL FIELD

The present invention relates to multi-in multi-out (MIMO) technology, and specifically to an apparatus and method for testing MIMO wireless terminal.

### BACKGROUND OF THE RELATED ART

In recent years, the MIMO technology has become one of main key technologies of the next generation of wireless communication, such as the long term evolution (UTE) plan of the 3^{rd} generation partnership project (3GPP), 802.16 family technology of broadband access standard of the institute of electrical and electronics engineers (IEEE), LTE-Advance technology and so on. The MIMO technology is a breakthrough in the radio frequency resource limitation, utilizing features of random fading and multipath delay dispersion of multiple transmission rates efficiently, improving the spectral efficiency and system performance of the new generation wireless communication system significantly without increasing the spectral bandwidth, thereby becoming a hot research of today's wireless communication.

Meanwhile, the wireless communication system and wireless terminal using the MIMO technology have gradually begun to be widely applied in practice. It is an issue focus on the radiation performance of a great variety of wireless terminals in the market. The radiation performance test includes final transmitting performance and reception performance of the wireless terminal. The method and standard for testing the radiation performance of the simple input simple output (SISO) wireless terminal have been applied maturely. The most common measurement scheme is an active test within a specific microwave chamber, for testing the space radio performance, such as the radiation power and so on, of the wireless terminal; or a passive test for examining the radiation performance of the wireless terminal in aspects of antenna radiation parameters, such as the gain, efficiency, pattern and so on, of the wireless terminal antenna. However, the testing and evaluating scheme and standard tier the radiation performance of the wireless terminal with MIMO are still under discussion.

### SUMMARY OF THE INVENTION

In view of that, the main purpose of the present invention is to provide an apparatus and method for testing a MIMO wireless terminal, wherein the simulation of output is in combination with the base station transmitting signal in MIMO downlink transmission mode during the test, which has a complete and reliable measurement result.

In order to achieve the above purpose, the technical scheme of the present invention is realized as follows: an apparatus for testing a multi-in multi-out (MIMO) wireless terminal comprises a MIMO transmission mode selecting unit and the MIMO transmission mode selecting unit comprises:

a mode selecting module, which is configured to: during a real-world over-the-air (OTA) test for the MIMO wireless terminal, select a MIMO downlink transmission mode required to be tested, and trigger a MIMO downlink transmission module corresponding to the selected MIMO downlink transmission mode; and

the MIMO downlink transmission module, which is configured to output a downlink test signal that conforms to a selected MIMO downlink transmission mode feature according to triggering of the mode selecting module.

Furthermore, the above-mentioned apparatus further comprises: a base station (BS) emulator and a multipath fading channel simulator, wherein,

the BS emulator is configured to simulate a base station outputting a signal to the MIMO transmission mode selecting unit;

the MIMO transmission mode selecting unit is further configured to receive a signal from the BS emulator and then select the MIMO downlink transmission mode that requires testing from multiple configured MIMO downlink transmission modes; and output a downlink signal that conforms to the selected MIMO downlink transmission mode feature to the multipath fading channel simulator;

the multipath fading channel simulator is configured to form a multipath fading delay signal from the downlink signal from the MIMO transmission mode selecting unit, and input the multipath fading delay signal into a chamber, to test the MIMO wireless terminal that is to be tested.

Furthermore, the above-mentioned apparatus further comprises: a base station (BS) emulator and a multipath fading channel simulator, wherein,

the BS emulator is configured to simulate the BS outputting a signal to the multipath fading channel simulator;

the multipath fading channel simulator is further configured to form a multipath fading delay signal from a signal from the BS emulator, and input the multipath fading delay signal to the MIMO transmission mode selecting unit;

the MIMO transmission mode selecting unit is further configured to receive a multipath fading delay signal from the multipath fading channel simulator and then select the MIMO downlink transmission mode that requires testing from multiple configured MIMO downlink transmission modes, and output a multipath fading delay signal that conforms to the selected MIMO downlink transmission mode feature into a chamber, to test the MIMO wireless terminal that is to be tested.

Furthermore, in the above-mentioned apparatus, the MIMO downlink transmission mode comprises one or more of: single antenna mode, closed-loop spatial multiplexing, open-loop spatial multiplexing, transmit diversity, spatial multiplexing, multi-user MIMO, pre-coding, and beam forming.

The present invention also provides an apparatus for selecting a multi-in multi-out (IMMO) wireless terminal transmission mode, comprising:

a mode selecting module, which is configured to: during a real-world over-the-air (OTA) test for the MIMO wireless terminal, select a MIMO downlink transmission mode that requires testing, and trigger a MIMO downlink transmission module corresponding to the selected MIMO downlink transmission mode; and

the MIMO downlink transmission module, which is configured to output a downlink test signal that conforms to a selected MIMO downlink transmission mode feature according to triggering of the mode selecting module.

Furthermore, the above-mentioned apparatus is further configured to: receive a signal from a BS emulator and then select the MIMO downlink transmission mode that requires testing from multiple configured MIMO downlink transmission modes, and output a downlink signal that conforms to the selected MIMO downlink transmission mode feature to a multipath fading channel simulator.

Furthermore, the above-mentioned apparatus is further configured to: receive the multipath fading delay signal from the multipath fading channel simulator and then select the MIMO downlink transmission mode that requires testing from multiple configured MIMO downlink transmission modes, and output the multipath fading delay signal that conforms to the selected MIMO downlink transmission mode feature into a chamber, to test the MIMO wireless terminal that is to be tested.

Furthermore, in the above-mentioned apparatus, the MIMO downlink transmission mode comprises one or more of: single antenna mode, closed-loop spatial multiplexing, open-loop spatial multiplexing, transmit diversity, spatial multiplexing, multi-user MIMO, pre-coding, and beam forming.

The present invention also provides a method for testing a multi-in multi-out (MIMO) wireless terminal, comprising:

during an OTA test for the MIMO wireless terminal, selecting a MIMO downlink transmission mode that requires testing from multiple configured MIMO downlink transmission modes, and outputting a downlink test signal that conforms to a selected MIMO downlink transmission mode feature.

Furthermore, the above-mentioned method further comprises: presetting a MIMO downlink transmission mode to be tested.

Furthermore, in the above-mentioned method, before the step of selecting the MIMO downlink transmission mode that requires testing, the method further comprises: simulating a base station outputting a signal;

after the step of outputting the downlink test signal that conforms to the selected MIMO downlink transmission mode feature, the method further comprises: forming a multipath fading delay signal from a downlink signal, and input the multipath fading delay signal into a chamber, to test the MIMO wireless terminal to be tested.

Furthermore, in the above-mentioned method, before the step of selecting the MIMO downlink transmission mode that requires testing, the method further comprises: simulating the base station outputting a signal; and forming a multipath fading delay signal from the signal;

the step of outputting the downlink test signal that conforms to the selected MIMO downlink transmission mode feature comprises: outputting the multipath fading delay signal that conforms to the selected MIMO downlink transmission mode feature into a chamber, to test the MIMO wireless terminal that is to be tested.

Furthermore, in the above-mentioned method, the step of testing the MIMO wireless terminal that is to be tested comprises: testing the MIMO wireless terminal that is to be tested by a chamber measurement method or a reverberation chamber measurement method.

Furthermore, in the above-mentioned method, the MIMO downlink transmission mode comprises one or more of: single antenna mode, closed-loop spatial multiplexing, open-loop spatial multiplexing, transmit diversity, spatial multiplexing, multi-user MIMO, pre-coding, and beam forming; and/or,

when one MIMO downlink transmission mode is selected, the step of selecting the MIMO downlink transmission mode that requires testing is realized by way of closing or opening a switch to select the MIMO downlink transmission mode that requires testing, and when multiple said MIMO downlink transmission modes are selected, the step of selecting the MIMO downlink transmission mode that requires testing is realized to select the MIMO downlink transmission modes that require testing in a polling way.

According to the scheme provided by the present invention, considering the influence of the system side MIMO downlink transmission mode, by the simulation of output in the test for the MIMO OTA radiation performance, especially for the reception sensitivity, combining the base station transmitting signal in the MIMO downlink transmission mode, fully consider the measurement for the different MIMO downlink transmission mode, and fully demonstrate the influence of the MIMO downlink transmission mode of the MIMO wireless communication system on the testing of the OTA radiation performance, especially the reception sensitivity of the MIMO wireless terminal, thereby completing the measurement scheme of the OTA radiation performance, especially the reception sensitivity of the MIMO wireless terminal and providing a more complete and reliable measurement result for the measurement of the radiation performance of the tested MIMO wireless terminal.

Furthermore, by way of combining the multipath fading channel simulator with the MIMO transmission mode selecting unit provided by the present invention, a more similar multipath fading delay signal is output, to measure the radiation performance, especially reception sensitivity of the tested MIMO wireless terminal.

### BRIEF DESCRIPTION OF DRAWINGS

FIG. 1 is a schematic diagram of the structure of the MIMO transmission mode selecting unit of the present invention;

FIG. 2 is a schematic diagram 1 of the structure of the MIMO OTA testing apparatus of the present invention;

FIG. 3 is a schematic diagram 2 of the structure of the MIMO OTA testing apparatus of the present invention;

FIG. 4 is a MIMO downlink transmission mode selecting flowchart during testing the MIMO wireless terminal in the present invention; and

FIG. 5 is a flowchart of testing of the MIMO wireless terminal of the present invention.

### PREFERRED EMBODIMENTS OF THE PRESENT INVENTION

In the new generation of wireless communication system using the MIMO technology, the base station side and wireless terminal side usually adopt the MIMO technology, therefore it is required to consider the case of adopting the MIMO technology in the base station side in the testing and evaluating scheme of radiation performance of the wireless terminal with MIMO, that is a MIMO wireless terminal. Especially for the testing for the reception sensitivity of the MIMO wireless terminal, the MIMO wireless signal output by simulating base station needs to be taken into account especially. In general, the MIMO downlink transmission has multiple modes such as: single antenna mode, closed-loop spatial multiplexing, open-loop spatial multiplexing, transmit diversity, spatial multiplexing, multi-user MIMO, pre-coding, and beam forming and so on.

In the present invention, during the real-world over-the-air OTA test for the MIMO wireless terminal, the MIMO downlink transmission mode that currently requires testing is selected from multiple configured MIMO downlink transmission modes, and the downlink test signal that conforms to the selected MIMO downlink transmission mode feature is output.

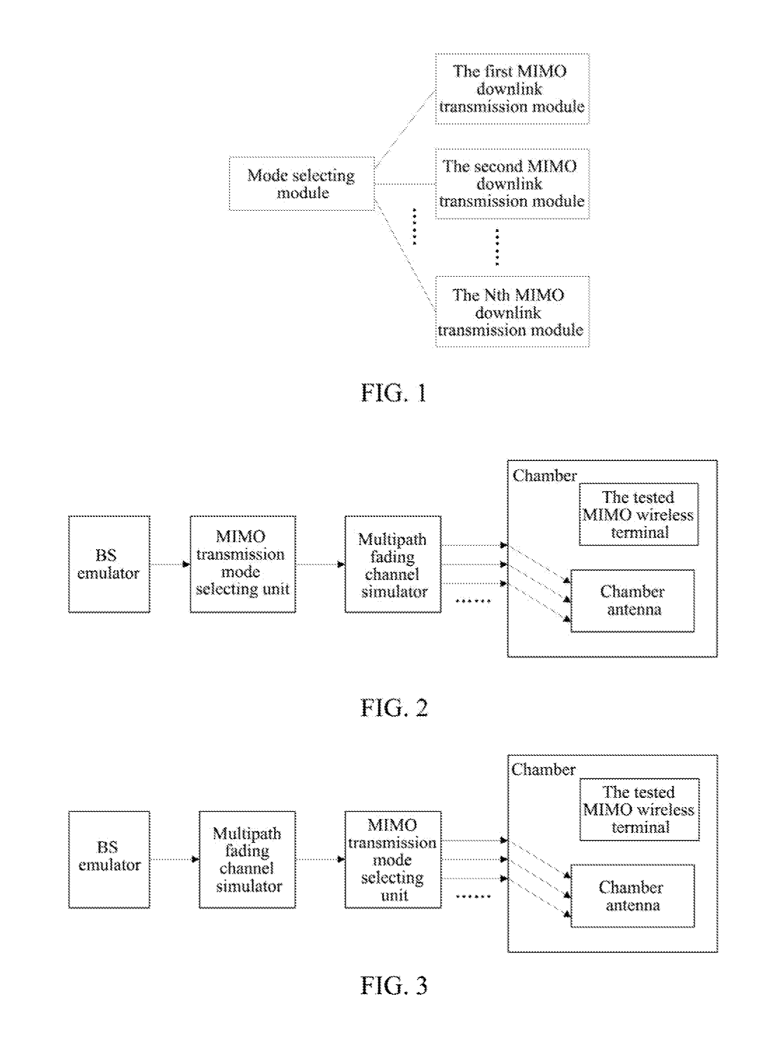

In the scheme of the present invention, the main idea is to add a MIMO transmission mode selecting unit in the MIMO OTA testing apparatus, the structure of which is as shown in FIG. 1, and the MIMO transmission mode selecting unit includes: a mode selecting module and a plurality of MIMO downlink transmission modules, wherein the mode selecting module is configured to: during the OTA test for the MIMO wireless terminal, select the MIMO downlink transmission mode that currently requires testing, and trigger the corresponding MIMO downlink transmission module; the MIMO downlink transmission mode is configured to output the downlink test signal that conforms to the selected MIMO downlink transmission mode feature according to the triggering of the mode selecting module.

The mode selecting module may specifically implement triggering the MIMO downlink transmission module by way of closing or opening the switch; or may implement triggering the MIMO downlink transmission module by way of sending a control command to the corresponding MIMO downlink transmission module. Each MIMO downlink transmission module corresponds to one MIMO downlink transmission mode, and different MIMO downlink transmission modules correspond to different MIMO downlink transmission modes.

During the process of OTA test for the MIMO wireless terminal, the mode selecting module may select only one MIMO downlink transmission mode at a time; or select multiple MIMO downlink transmission modes or even all downlink transmission modes at a time. When multiple MIMO downlink transmission modes are selected, the mode selecting module may test the MIMO wireless terminal in various MIMO downlink transmission modes one by one in a polling way, that is, the mode selecting module triggers the test for the next MIMO downlink transmission mode when confirming the test of one MIMO downlink transmission mode is finished.

The MIMO transmission mode selecting unit provided by the present invention may be added between the base station (BS) emulator and the multipath fading channel simulator in the MIMO OTA apparatus, as shown in FIG. 2; or may be added after the multipath fading channel simulator in the MIMO OTA apparatus, as shown in FIG. 3.

In the structure shown in FIG. 2, the BS emulator is configured to simulate the base station outputting a signal to the MIMO transmission mode selecting unit; the MIMO transmission mode selecting unit is configured to receive the signal from the BS emulator and then select the MIMO downlink transmission mode that currently requires testing from multiple configured MIMO downlink transmission modes, and output the downlink signal that conforms to the selected MIMO downlink transmission mode feature to the multipath fading channel simulator; the multipath fading channel simulator is configured to form a multipath fading delay signal from the downlink signal from the MIMO transmission mode selecting unit, and input the multipath fading delay signal into a chamber, to test the MIMO wireless terminal that is to be tested.

In the structure shown in FIG. 3, the BS emulator is configured to simulate the BS outputting a signal to the multipath fading channel simulator; the multipath fading channel simulator is configured to form a multipath fading delay signal from the signal from the BS emulator, and input the multipath fading delay signal to the MIMO transmission mode selecting unit; the MIMO transmission mode selecting unit is configured to receive the multipath fading delay signal from the multipath fading channel simulator and then select the MIMO downlink transmission mode that currently requires testing from multiple configured MIMO downlink transmission modes, and output the multipath fading delay signal that conforms to the selected MIMO downlink transmission mode feature into a chamber, to test the MIMO wireless terminal that is to be tested.

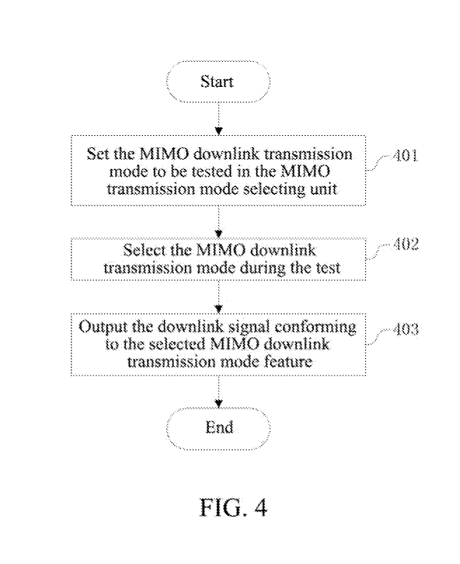

FIG. 4 is a MIMO downlink transmission mode selecting flowchart during testing the MIMO wireless terminal in the present invention, as shown in FIG. 4, which specifically includes:

Step 401, the tester presets the MIMO downlink transmission mode to be tested in the MIMO transmission mode selecting unit.

The step of setting the MIMO downlink transmission mode to be tested mentioned herein refers to setting each MIMO downlink transmission mode that may have a test requirement rather than all of the MIMO downlink transmission modes for which the test is finished in one testing process. For example, according to the testing requirement, three MIMO downlink transmission modes to be tested are preset: transmit diversity, spatial multiplexing and multi-user MIMO, and in a certain test, only the mode of spatial multiplexing may be as the MIMO downlink transmission mode that needs to be tested of this test.

According to requirement of test, the tester pre-configures each MIMO downlink transmission module in the MIMO transmission mode selecting unit, to correspond to each MIMO downlink transmission mode to be tested, for example, configuring three MIMO downlink transmission modules to be tested which respectively correspond to three MIMO downlink transmission modes, single antenna mode, closed-loop spatial multiplexing and open-loop spatial multiplexing.

Step 402: during the process of OTA test for the MIMO wireless terminal, the MIMO transmission mode selecting unit selects the MIMO downlink transmission mode that requires testing. The MIMO transmission mode selecting unit may select the MIMO downlink transmission mode that requires testing according to the input of the tester or the self configuration.

Step 403: the MIMO transmission mode selecting unit outputs the downlink test signal conforming to the selected MIMO downlink transmission mode feature.

During the OTA test for the MIMO wireless terminal, the MIMO transmission mode selecting unit may select only one MIMO downlink transmission mode at a time; or select multiple MIMO downlink transmission modes or even all downlink transmission modes at a time. When one MIMO downlink transmission mode is selected, selecting the corresponding MIMO downlink transmission mode may be realized by way of closing or opening a switch. When multiple MIMO downlink transmission modes are selected, the MIMO transmission mode selecting module may realize the selecting of various MIMO downlink transmission modes one by one in a polling way, that is, the MIMO transmission mode selecting unit selects the next MIMO downlink transmission mode to continue the OTA test for the MIMO wireless terminal when confirming the test of one MIMO downlink transmission mode is finished, that is to say, repeat the step 403 in each MIMO downlink transmission mode.

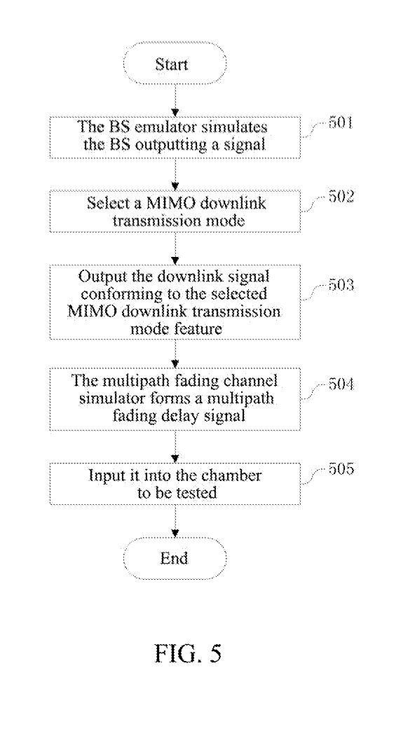

FIG. 5 is a flowchart of testing of the MIMO wireless terminal of the present invention, and as shown in FIG. 5, it specifically includes:

Step 501: the BS emulator simulates the BS outputting a signal to the MIMO transmission mode selecting unit.

Step 502: the MIMO transmission mode selecting unit receives the signal from the BS emulator, and then selects the MIMO downlink transmission mode that currently requires testing from multiple configured MIMO downlink transmission modes.

Step 503: the MIMO transmission mode selecting unit outputs the downlink signal that conforms to the selected MIMO downlink transmission mode feature to the multipath fading channel simulator.

Step 504: the multipath fading channel simulator forms a multipath fading delay signal from the downlink signal from the MIMO transmission mode selecting unit.

Step 505: the multipath fading channel simulator inputs the multipath fading delay signal into a chamber, to test the MIMO wireless terminal that is to be tested.

If the MIMO transmission mode selecting unit selects multiple MIMO downlink transmission modes, repeat the steps 503˜505 by way of polling.

In combination with the description of FIG. 3, the multipath fading channel simulator may form the multipath fading delay signal firstly, and then the MIMO transmission mode selecting unit outputs the multipath fading delay signal that conforms to the selected MIMO downlink transmission mode feature.

In the present invention, the test for the radiation performance of the MIMO wireless terminal in the chamber may be a chamber measurement method, or may be a reverberation chamber measurement method.

The above description is only the preferred embodiment of the present invention, which is not intended to limit the protection scope of the present invention. Obviously, those skilled in the art may make various changes and variations to the present invention without departing from the spirit and scope of the present invention. Thus, if these changes and variations of the present invention fall into the scope of the claims of the present invention and the equivalent technology, they are also included in the present invention.

### INDUSTRIAL APPLICABILITY

The technical scheme provided by the present invention takes the influence of the system side MIMO downlink transmission mode into account, and in the test for the MIMO OTA radiation performance, especially for the reception sensitivity, the simulation of output combines with the base station transmitting signal of MIMO downlink transmission mode, fully considering the measurement for different MIMO downlink transmission modes, and fully demonstrating the influence of the MIMO downlink transmission mode of the MIMO wireless communication system on the testing of the OTA radiation performance, especially the reception sensitivity of the MIMO wireless terminal, thereby completing the measurement scheme of the OTA radiation performance, especially the reception sensitivity testing of the MIMO wireless terminal and providing a more complete and reliable measurement result for the measurement of the radiation performance of the tested MIMO wireless terminal.

Furthermore, by combining the multipath fading channel simulator with the MIMO transmission mode selecting unit provided by the present invention, a more similar multi path fading delay signal is output, to measure the radiation performance, especially reception sensitivity of the tested MIMO wireless terminal.

What is claimed is:

1. An apparatus for testing a multi-in multi-out (MIMO) wireless terminal, comprising a MIMO transmission mode selecting unit, wherein the MIMO transmission mode selecting unit comprises:
a mode selecting module, which is configured to: during a real-world over-the-air (OTA) test for the MIMO wireless terminal, select a MIMO downlink transmission mode that requires testing, and trigger a MIMO downlink transmission module corresponding to the selected MIMO downlink transmission mode; and
the MIMO downlink transmission module, which is configured to output a downlink test signal that conforms to a feature of the selected MIMO downlink transmission mode according to triggering of the mode selecting module.

2. The apparatus according to claim 1, further comprising: a base station (BS) emulator and a multipath fading channel simulator, wherein,
the BS emulator is configured to simulate a base station outputting a signal to the MIMO transmission mode selecting unit;
the MIMO transmission mode selecting unit is further configured to receive the signal from the BS emulator and then select the MIMO downlink transmission mode that requires testing from multiple configured MIMO downlink transmission modes, and output a downlink signal that conforms to a selected MIMO downlink transmission mode feature to the multipath fading channel simulator;
the multipath fading channel simulator is configured to form a multipath fading delay signal from the downlink signal from the MIMO transmission mode selecting unit, and input the multipath fading delay signal into a chamber to test the MIMO wireless terminal that is to be tested.

3. The apparatus according to claim 1, further comprising: a base station (BS) emulator and a multipath fading channel simulator, wherein,
the BS emulator is configured to simulate a base station outputting a signal to the multipath fading channel simulator;
the multipath fading channel simulator is configured to form a multipath fading delay signal from the signal from the BS emulator, and input the multipath fading delay signal to the MIMO transmission mode selecting unit;
the MIMO transmission mode selecting unit is further configured to receive the multipath fading delay signal from the multipath fading channel simulator and then select the MIMO downlink transmission mode that requires testing from multiple configured MIMO downlink transmission modes, and output the multipath fading delay signal that conforms to a selected MIMO downlink transmission mode feature into a chamber to test the MIMO wireless terminal that is to be tested.

4. The apparatus according to claim 1, wherein the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming.

5. An apparatus for selecting a multi-in multi-out (MIMO) wireless terminal transmission mode, comprising:
a mode selecting module, which is configured to: during a real-world over-the-air (OTA) test for a MIMO wireless terminal, select a MIMO downlink transmission mode that requires testing, and trigger a MIMO downlink transmission module corresponding to the selected MIMO downlink transmission mode; and
the MIMO downlink transmission module, which is configured to output a downlink test signal that conforms to a feature of the selected MIMO downlink transmission mode according to triggering of the mode selecting module.

6. The apparatus according to claim 5, further configured to: receive a signal from a BS emulator and then select the MIMO downlink transmission mode that requires testing from multiple configured MIMO downlink transmission modes, and output a downlink signal that conforms to a selected MIMO downlink transmission mode feature to a multipath fading channel simulator.

7. The apparatus according to claim 5, further configured to: receive a multipath fading delay signal from a multipath fading channel simulator and then select the MIMO downlink transmission mode that requires testing from multiple configured MIMO downlink transmission modes, and output the multipath fading delay signal that conforms to a selected MIMO downlink transmission mode feature into a chamber, to test the MIMO wireless terminal that is to be tested.

8. The apparatus according to claim 5, wherein, the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming.

9. A method for testing a multi-in multi-out (MIMO) wireless terminal, comprising:
during an OTA test for the MIMO wireless terminal, selecting a MIMO downlink transmission mode that requires testing from multiple configured MIMO downlink transmission modes, and outputting a downlink test signal that conforms to a selected MIMO downlink transmission mode feature.

10. The method according to claim 9, further comprising: presetting a MIMO downlink transmission mode to be tested.

11. The method according to claim 9, wherein, before the step of selecting the MIMO downlink transmission mode that requires testing, the method further comprises: simulating a base station outputting a signal;
after the step of outputting the downlink test signal that conforms to the selected MIMO downlink transmission mode feature, the method further comprises: forming a multipath fading delay signal from the downlink signal, and input the multipath fading delay signal into a chamber, to test the MIMO wireless terminal to be tested.

12. The method according to claim 9, wherein, before the step of selecting the MIMO downlink transmission mode that requires testing, the method further comprises: simulating a base station outputting a signal; and form a multipath fading delay signal from the signal;
the step of outputting the downlink test signal that conforms to the selected MIMO downlink transmission mode feature comprises: outputting the multipath fading delay signal that conforms to the selected MIMO downlink transmission mode feature into a chamber, to test the MIMO wireless terminal that is to be tested.

13. The method according to claim 11, wherein, the step of testing the MIMO wireless terminal that is to be tested comprises: testing the MIMO wireless terminal that is to be tested by a chamber measurement method or a reverberation chamber measurement method.

14. The method according to claim 9, wherein, the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming; and/or,
when one said MIMO downlink transmission mode is selected, the step of selecting the MIMO downlink transmission mode that requires testing is realized by way of closing or opening a switch to select the MIMO downlink transmission mode that requires testing; when multiple said MIMO downlink transmission modes are selected, the step of selecting the MIMO downlink transmission mode that requires testing is realized by selecting the MIMO downlink transmission modes that require testing one by one in a polling way.

15. The apparatus according to claim 2, wherein the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming.

16. The apparatus according to claim 3, wherein the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming.

17. The apparatus according to claim 6, wherein, the MIMO downlink transmission mode comprises one or more of: single antenna mode, closed-loop spatial multiplexing, open-loop spatial multiplexing, transmit diversity, spatial multiplexing, multi-user MIMO, pre-coding and beam forming.

18. The apparatus according to claim 7, wherein, the MIMO downlink transmission mode comprises one or more of: single antenna mode, closed-loop spatial multiplexing, open-loop spatial multiplexing, transmit diversity, spatial multiplexing, multi-user MEMO, pre-coding and beam forming.

19. The method according to claim 12, wherein, the step of testing the MIMO wireless terminal that is to be tested comprises: testing the MIMO wireless terminal that is to be tested by a chamber measurement method or a reverberation chamber measurement method.

20. The method according to claim 10, wherein, the MIMO downlink transmission mode comprises one or more of: single antenna mode, closed-loop spatial multiplexing, open-loop spatial multiplexing, transmit diversity, spatial multiplexing, multi-user MEMO, pre-coding and beam forming; and/or,
when one said MIMO downlink transmission mode is selected, the step of selecting the MIMO downlink transmission mode that requires testing is realized by way of closing or opening a switch to select the MIMO downlink transmission mode that requires testing: when multiple said MIMO downlink transmission modes are selected, the step of selecting the MIMO downlink transmission mode that requires testing is realized by selecting the MIMO downlink transmission modes that require testing one by one in a polling way.
